(19) United States
(12) Patent Application Publication
(10) Pub. No.: US 2004/0166051 A1
(43) Pub. Date: Aug. 26, 2004

(54) Preparation of non corrosive aluminum sulfate

(76) Inventors: Benjamin Shultes III, Liverpool, NY (US); Karen Elizabeth Ruehl, Ballwin, MO (US)

Correspondence Address: GENERAL CHEMICAL PERFORMANCE PRODUCTS LLC., 90 EAST HALSEY ROAD, PARSIPPANY, NJ, 07054, US

(21) Appl. No.: 10/791,620

(22) Filed: Mar. 2, 2004

Related U.S. Application Data
(63) Continuation-in-part of application No. 10/244,692, filed on Sep. 16, 2002.

(51) Int. Cl. C01F 7/74

(52) U.S. Cl. 423/556; 423/269

(57) ABSTRACT

The addition of an alkali to aluminum sulfate raises the pH, increases that cationic charge, improves performance as compared to aluminum sulfate alone and causes the aluminum sulfate to be non-corrosive to skin and metal. The addition of a minor quantity of phosphoric acid also provides added stability to the product.

The advantages of this modified alum include improved floc performance over standard alum and other polyaluminum chloride (PACl) products. The product of the invention (by varying the percent of soda ash to alum) has the potential to compete with polyaluminum chloride products using alum-based products. The polyaluminum sulfate products of the invention do not decrease the pH of treated water, as much as alum and performs more like a PACl product. The polyaluminum sulfate (PAS), like the PACl works well in low alkalinity waters. The PAS products have been found to remove total organic carbon and lower turbidity very efficiently.

This is a Continuation-in-Part Application of application Ser. No. 10/244,692 filed on Sep. 16, 2002

The invention relates to a relatively non-hazardous aluminum sulfate which is substantially less corrosive than the conventional or standard commercial product. More particularly the invention comprises the provision of aluminum sulfate that is processed via the addition of an alkali. Alkaline materials that may be employed as the additive are well known and are available commercially and include for example, sodium carbonate (soda ash), sodium bicarbonate, sodium hydroxide and lime or mixtures thereof. The alkali added to liquid aluminum sulfate functions to raise the pH and to thereby increase the cationic charge and improve the performance of alum. The processed aluminum sulfate made by the herein described process produces a relatively more efficient polyaluminum sulfate commercial product.

### BACKGROUND OF THE INVENTION

Aluminum sulfate is derived commercially by the reaction of bauxite or kaolin clay with sulfuric acid (30-60%) generally by the use of raw materials that are naturally low in iron and potassium to avoid the difficult removal of iron. The iron-free grade (<0.005% Fe₂O₃ max) is produced by using pure alumina trihydrate, Al₂O_{3.}3H₂O, in place of the bauxite or clay. A major use of aluminum sulfate or alum occurs in the paper industry wherein it is used to clarify process waters and to control the pH of pulp slurries. Another important use is in the treatment of potable water and for processing waste waters. Aluminum sulfate has other major uses as well, including, for example, the manufacture of soaps, chemicals, pharmaceuticals, greases, fire-extinguishing solutions, leather tanning, foods and modifying concrete.

The maximum commercial concentration of the aluminum sulfate (alum) produced is about 48.5% by weight and at this concentration and even at substantially lower concentrations, alum poses a significant hazard. In particular, as federal, state and local requirements for water purity become more stringent, the level of environmental concerns increases so that means of purifying water that reaches ground, rivers and lakes to higher levels continue to be sought. Aluminum sulfate (alum) solutions is not exempt from these concerns.

Accordingly, a means for the production of a less toxic commercial alum that significantly lessen the hazards posed by this widely used product is of substantial benefit.

### SUMMARY OF THE INVENTION

A present process for manufacturing aluminum sulfate or other aluminum-bearing ores is to digest bauxite ores containing hydrated aluminum (Al₂O₃3H₂O) with sulfuric acid. The maximum commercial concentration of the aluminum sulfate (alum) produced is about 48.5% by weight a concentration that poses a substantially environmental consideration. In accordance with the invention we have discovered that by the addition of a well known alkali, including, for example, soda ash, sodium bicarbonate, sodium hydroxide and lime as a mixture of such alkali, preferably including soda ash, to the liquid aluminum sulfate in the course of manufacture, a substantially superior product is obtained. In the alum containing the addition of the alkali, the pH is raised substantially, the cationic charge increases and the performance of the alum produced, i.e., the polyaluminum sulfate product, is improved; and, most importantly, the aluminum sulfate is rendered less corrosive to the skin as well as to metal. We have found also that, the addition of a minor amount, up to about 5% preferably from about 0.2% to about 3% by weight based on the total weight of the product, of phosphoric acid affords a product enhancement for some products.

### DETAILED DESCRIPTION OF THE INVENTION

One process for manufacturing aluminum sulfate is to digest bauxite ores containing hydrated alumina (Al₂O₃3H₂O) use in lieu thereof, aluminum trihydrates with sulfuric acid. The maximum commercial concentration of the aluminum sulfate (alum) produced is about 48.5% by weight. During the process some of the alum residue created during manufacture is entrained with some of the wash water and transferred to containment ponds. This water will then percolate into the soil, carrying with it aluminum and sulfate ions in measurable amounts, unless they are removed from the wash waters first. In order to meet, and preferably to exceed, the minimum levels set by various federal and state standards for drinking water prior to disposal of such water into the public waterways, these ions must be removed from the entrained water. In the manufacturing process it is apparent that even the process for aluminum contain about 56 ppm of iron, 18,400 ppm of sulfate and 2900 ppm of aluminum, and thus these solutions must be purified before they can be discharged into the public waters and, further, have a pH of between 6.5-8.5. Thus the waste solution must also be treated, as with an alkali, to increase the pH to within the designated range. It is apparent therefore that the production of a less corrosive alum not only results in a beneficial product but also alleviates much of the waste water problem associated with alum manufacture.

We have discovered that by adding various levels of alkaline additives, in particular those selected from soda ash, sodium bicarbonates sodium hydroxide and hydrated lime or a mixture thereof, to the standard aluminum sulfate, a product is derived that is non-corrosive to skin and to aluminum and carbon steel metals. By varying the amount of the alkali added to aluminum sulfate (usually 0.05 to 20 weight percent) a novel product is obtained. The new product is referred to herein as polyaluminum sulfate (PAS), a polyaluminum sulfate that has a higher pH, improved stability and a higher cationic charge which causes the basicity to increase and, thus, causes improved performance. Additionally, from about 0.05 to 5% phosphoric acid based on the total weight percent of the product can be added to the alkali modified alum mixture for improved stability and to enhance floc formation, thus, improving the effects derived from the alum treatment.

The advantages of the novel modified alum of the invention are to improve floc performance over standard alum and other inorganic coagulants, and to make the product non-corrosive to skin and metal.

The alum product derived in accordance with the invention (by varying the percent of alkali to alum) has the potential to compete with polyaluminum chloride (PACl) products using alum-based products and thereby afford a significant economic edge.

The preparation of the alkali modified alum in accordance with the invention involves the addition of various different weight percents of the alkali; such as soda ash (sodium carbonate), sodium bicarbonate, sodium hydroxide or lime including hydrated lime (of the kind that is available from Mississippi Lime) to the alum and mixed for a period of time until all of the alkali additive has dissolved. Preferred additives, soda ash or comprise a mixture of soda ash in which a portion thereof, may be substituted with another base additive such as sodium bicarbonate, caustic soda, hydrated lime, and the like. The additive treated alum solution is suitably filtered to remove insoluble materials. The product derived comprises a 5-50% basic polyaluminum sulfate product of superior stability, performance, that is non-corrosive to skin and metal.

The inventions will be described in greater detail by reference to the following examples. However, the invention is not to be considered as limited by the details presented therein.

General Procedure

An alum corrosion study was conducted to determine if alum could be labeled as non-corrosive material by altering its characteristics slightly, yet still meet all federal DOT regulations for shipment purposes. The test was conducted for a two week period under two temperature conditions: one at room temperature, the other at 130° F.

Corrosion rates were determined on three metals: carbon steel (C1020), aluminum metal (AL7075) and stainless steel (316L). As per the specifications in the Code of Federal Regulations, 49 CFR 173.137, if the corrosion rate exceeds 6.25 mm (0.25 inches yr., 250 mil/yr), then it is considered corrosive.

Corrosion rates were determined as follows:

$$Corrosion rate = \frac{weight difference \times 534000}{Metal Density \times Metal Area \times Time Exposure ( hr )}$$

Metal densities for C1020 is 7.87 gm/cm3; AL7075 is 2.80 gm/cm3; 316L is 7.98 gm/cm3.

Metal area is 3.38 sq. inches.

Time exposure is 336 hours.

Plugging in the numbers will give the corrosion rate in mils/yr. As long as the corrosion rate does not exceed 250 mils/yr. based on a test temperature of 130° F., the alum can be regarded and shipped as non-corrosive. All testing done was based on federal testing procedures and standards.

To facilitate a further description of the invention reference will primarily describe soda ash as the preferred alkali additive to alum although the use of an alternative alkaline or mixture of known alkaline chemicals may also be used as the alum enhancing additive. Addition of the alkali is preferably mixed into a relatively cold alum solution or slurry at a temperature from about 20° C. to about 44° C.

To produce the non-corrosive alum product in accordance with the invention the alum is modified by the addition of the soda ash or other alkali to produce a higher pH and positively charged product. Mixtures from 1 to 10% of soda ash is added to the alum. Results are shown in Tables I and II. To make the material non-corrosive, a characteristic which may be affected by the particular chemical composition of the alum, as well as the alkaline additive, it may be necessary to increase the relative portion of the soda ash and/or the alkali to achieve a corrosion rate below 250 mil/yr. The aluminum and 316 stainless steel coupons passed all corrosivity rate testing at both testing temperatures in the examples, demonstrating that corrosivity levels can be controlled by the amount of alkali added.

While the addition of the alkali to control corrosivity introduces a slight increase in cost to produce the product of the invention, the benefits of the non-corrosive alum produced in accordance with the invention far outweigh the cost. Alum can now be produced as two different products; corrosive vs. non-corrosive. The testings of the non-corrosive alum comprising the polyaluminum sulfate of the present invention was done according to government testing procedures with an adjustment for corrosivity rates by varying the levels of lime and/or soda ash to keep within federal guidelines for shipping.

TABLE I

| Alum % | | Phosphoric | Mixing | Product |
|---|---|---|---|---|
| Used | Alkali % | Acid % | Condition | Character |
| 89 | Soda Ash | — | Cold | Good |
| 91 | Soda Ash 9 | — | Cold | Good |
| 89 | Soda Ash 6 | — | Cold | Good |
| | Lime 5 | | | |
| 89 | Soda Ash 6 | — | Hot (˜55° C.) | Good |
| | Lime 5 | | | Slight Haze |
| 89 | NaOH7 | — | Cold | Hazy |

TABLE II
SAMPLES: Alum mixed with Lime (1%-A, 3%-B, 5%-C, 10%-D)
1/25/02

| SAMPLE | % Al₂O₃ | % Basicity | Specific Gravity | pH |
|---|---|---|---|---|
| Lime 1% | 8.35 | 6.61 | 1.321 | 2.37 |
| STC #9759 | | | | |
| Lime 3% | 8.39 | 10.0 | 1.307 | 2.54 |
| STC #9760 | | | | |
| Lime 5% | 8.35 | 23.6 | 1.267 | 2.83 |
| STC #9761 | | | | |
| Lime 10% | 8.41 | 40.4 | 1.219 | 3.18 |
| STC #9762 | | | | |

Shown in Table III is the packing group assignment which indicates what packing group a product is assigned based on its corrositex time.

TABLE III
PACKING GROUP ASSIGNMENT TABLE

| | CORROSITEX Time (in Minutes) | | | |
|---|---|---|---|---|
| Category | 0 to 3 min. | >3 to 60 min. | >60 to 240 min. | >240 min. |
| 1 | | | | |
| Category | 0 to 3 min. | >3 to 330 min. | >30 to 60 min. | >60 min. |
| 2 | | | | |
| | □ | □ | □ | □ |
| | Packing | Packing | Packing | Non- |
| | Group I | Group II | Group III | Corrosive |

Although the invention has been described in terms of particular embodiments, blends of one or more of the various additives described herein can be used, and substitutes therefore, as will be known to those skilled in the art. Thus the invention is not meant to be limited to the details described herein, but only by the scope of the appended claims.

What is claimed:

1. A method for the manufacture of a relatively non-corrosive aluminum sulfate which comprise
(a) introducing and mixing an alkali into a solution of aluminum sulfate having a concentration of between about 82% to 97% by weight and in sufficient amounts and such that when the alkali is substantially dissolved, the pH of the solution yields a polyaluminum sulfate product having an elevated cationic changes of at least 5, and
(b) filtering the polyaluminum sulfate reaction product.

2. The method of claim 1 wherein the quantity of alkali introduced and mixed into the aluminum sulfate solution comprises from about 3% to about 15% by weight of the aluminum sulfate.

3. The method of claim 1 wherein the alkali is soda ash.

4. The method of claim 1 wherein the alkali is lime.

5. The method of claim 4 wherein the lime is hydrated lime or lime.

6. The method of claim 1 wherein the alkali is sodium hydroxide.

7. The method of claim 1 wherein the alkali is sodium bicarbonate.

8. The method of claim 1 wherein the alkali is a blend of sodium carbonate and lime.

9. The method of claim 1 wherein the solution of aluminum sulfate has a concentration of between about 85% to about 97% by weight and the alkali comprises between about 3% to 15% by weight.

10. The method of claim 9 in which the alkali is soda ash and wherein about 1.0% phosphoric acid is added.

11. The method of claim 10 in which the alkali is soda ash and wherein 1.0% to about 3% phosphoric acid is added.

12. A relatively non-corrosive aluminum sulfate product comprising the reaction product of between about 85% to about 97% by weight of aluminum sulfate and between about 3% and about 15% by weight of an alkali.

13. The product of claim 12 in which the alkali is soda ash.

14. The product of claim 12 in which the alkali is lime or soda ash.

15. The product of claim 14 in which the reaction product incorporates from about 0.5% to about 5% by weight of phosphoric acid.
